(19) United States
(12) Patent Application Publication
(10) Pub. No.: US 2018/0064105 A1
(43) Pub. Date: Mar. 8, 2018

(54) INSECT REPELLING SYSTEM

(71) Applicant: Abe Taylor, Bronson, TX (US)

(72) Inventor: Abe Taylor, Bronson, TX (US)

(21) Appl. No.: 15/256,499

(22) Filed: Sep. 2, 2016

(51) Int. Cl. A01N 25/34; A01N 53/00; A01N 65/44; A01N 37/18; A01M 29/12

(52) U.S. Cl. CPC A01N 25/34; A01N 53/00; A01M 29/12; A01N 37/18; A01N 65/44

(57) ABSTRACT

An insect repelling system including an insect repellant table setting including at least one place-setting having at least one place mat, at least one beverage holder, at least one coaster, and at least one table cloth treated with insect repellant to make outdoor dining more enjoyable for food and drink consumers by repelling insects from an area proximate to the insect repellant table setting.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of insect repelling solutions and more specifically relates to an insect repelling system.

### 2. Description of Related Art

Mosquitos, ticks and other bugs may be a nuisance. These bugs also can bite and may carry harmful bacteria and/or diseases. During the last decade, intensive research has been carried on for materials capable of repelling insects and suitable for use on cloths. As a consequence, several compounds having the property of repelling insects such as mosquitoes, flies, gnats, chiggers, mites and the like, have been developed which may be safely applied on the cloths. Foremost among these at present are such compounds as 2-phenylcyclohexanol, 2-cyclohexylcyclohexanol, dimethyl carbate, dimethyl phthalate, n-butyl mesityl oxide oxalate and 2-ethyl 1, 3 hexane diol. The aforementioned compounds are characterized by being insect repellent, having at the most occasional and very minor toxicity, and having a low volatility at ordinary skin temperatures.

Although these compounds have very effective insect repellent characteristics, they have been found to be effective only for limited periods of time, necessitating repeated and often inconvenient applications of the material to the skin. At the present time, these repellents have an average effectiveness of approximately 2 hours. As they are generally of low volatility, it is possible that they are absorbed in the skin and thereby rendered ineffective. No effective preventive measures exist for other mosquito borne diseases such as dengue, chikungunya, Zika, and West Nile encephalitis or tickborne diseases such as Lyme borreliosis, tickborne encephalitis, and relapsing fever. A suitable solution is desired.

Several attempts have been made to solve the above-mentioned problems such as those found in U.S. Pub. No. 2008/0175879 to Terry Feinberg, and U.S. Pat. No. 6,065,428 to Lawrence Fronk. This art is representative of insect repellent solutions. However, none of the above inventions and patents, taken either singly or in combination, is seen to describe the invention as claimed.

### BRIEF SUMMARY OF THE INVENTION

In view of the foregoing disadvantages inherent in the known insect repellent art, the present invention provides a novel insect repellent solution for use with items. The general purpose of the present invention, which will be described subsequently in greater detail is to provide an insect repelling system for effectively repelling insects from places where food is to be injested.

An insect repelling system is disclosed herein, in a preferred embodiment, comprising an insect repellant table setting having at least one place-setting including at least one place mat, at least one beverage holder, and at least one coaster, and at least one table cloth. The insect repellant table setting comprises in functional combination the least one place-setting and the at least one table cloth. The at least one place-setting comprises at least the at least one place mat, the at least one beverage holder and the at least one coaster to be used for outdoor dining purposes. The insect repellant table setting is treated with insect repellant such that during the outdoor dining is made more enjoyable for food and drink consumers by repelling insects from an area proximate to the insect repellant table setting. Use of 2-phenylcyclohexanol, 2-cyclohexylcyclohexanol, dimethyl carbate, dimethyl phthalate, n-butyl mesityl oxide oxalate and 2-ethyl 1, 3 hexane diol may be used or other suitable means known in the art.

The treating preferably comprises impregnation. The insect repellant may comprise permethrin. If used, the permethrin is preferably imbued and infused with fabric of the insect repellant table setting. The insect repellant comprises citronella oil for repelling insects. The insect repellant is environmentally-friendly. The insect repellant is non-toxic. The insect repellant is herbal and prevents insects from coming near and landing on drinks and the food outside. The insect repellant table setting is coated with a non-stick material to further assist in preventing movement of crawling insects. The at least one beverage holder is an insulated koozie. The insulated koozie is designed for holding and insulating a bottled drink. The at least one table cloth is flexible. The at least one coaster comprises a greater circumference than that of a base of the at least one beverage holder. The at least one coaster provides a protective layer between the at least one table cloth and the at least one beverage holder. The insect repellant comprises nn-diethyl-meta-toluamide for protection against insect bites.

The present invention holds significant improvements and serves as an insect repelling system. Preferably, an insect repellent should provide a means to effectively repel insects and, yet would operate reliably and be manufactured at a modest expense. Thus, a need exists for a reliable insect repelling system to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, insect repelling systems, constructed and operative according to the teachings of the present disclosure.

FIG. 1 shows a perspective view illustrating an insect repelling system during an ‘in-use’ condition according to an embodiment of the disclosure.

FIG. 2 is a perspective view illustrating the insect repelling system comprising an insect repellant table setting according to an embodiment of the present invention of the disclosure.

FIG. 3 is a perspective view illustrating the insect repellant table setting according to an embodiment of the present disclosure.

FIG. 4 is a perspective view illustrating the insect repellant table setting according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an insect repellent solution and more particularly to an insect repelling system as used to improve the means for repelling insects away from food and beverages while dining outdoors.

Generally speaking, the insect repelling system comprises a natural insect repellant i.e. citronella which is coated on outdoor table settings, coasters, table clothes and koonzies. Citronella oil repels insects such as mosquitoes, black flies, fleas and ticks, therefore, preventing its bites. It is used on humans and their clothing in the form of an oil, liquid and patch. Citronella oil is a natural, non-toxic alternative to chemical insect repellents such as DEET, therefore, is usually the preferred choice. Citronella oil is also used in a tablet or pellet form in recreational or outdoor household areas and around trees and shrubs. The structures of the invention are relatively inexpensive and facile to manufacture, and they are highly convenient and effective to use.

The present invention accomplishes a natural insect repellent solutions for outdoor table settings, table clothes, place settings, coasters and koozies capable of repelling insects away from the beverages and food. It will repel bacteria carrying insects away from food and beverages.

The preferred embodiment of the present invention comprises a natural insect repellant i.e. citronella which is coated on outdoor table settings, coasters, table clothes and koonzies. Citronella oil repels insects such as mosquitoes, black flies, fleas and ticks, therefore, preventing its bites. It is used on humans and their clothing in the form of an oil, liquid and patch. Citronella oil is a natural, non-toxic alternative to chemical insect repellents such as DEET, therefore, is usually the preferred choice. Citronella oil is also used in a tablet or pellet form in recreational or outdoor household areas and around trees and shrubs. The structures of the invention are relatively inexpensive and facile to manufacture, and they are highly convenient and effective to use.

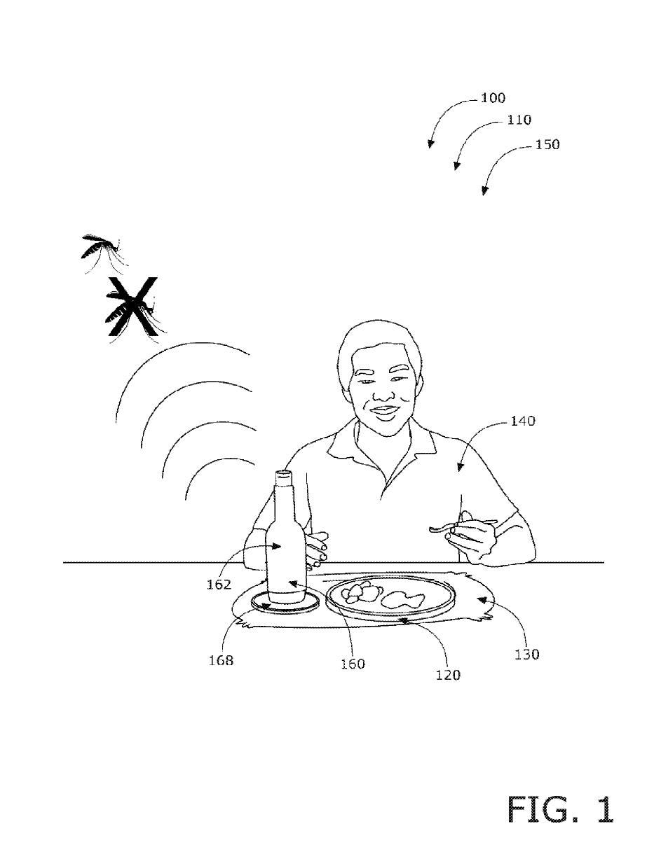

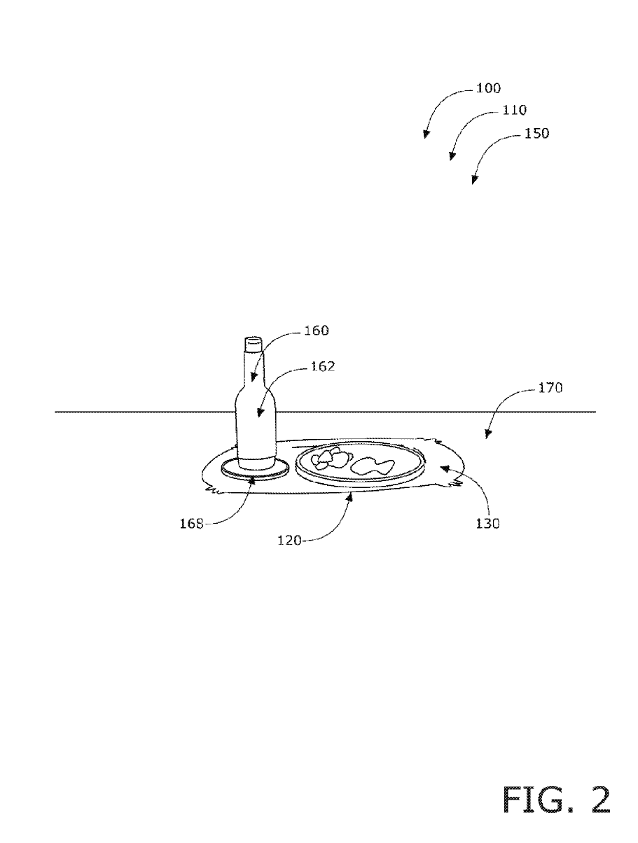

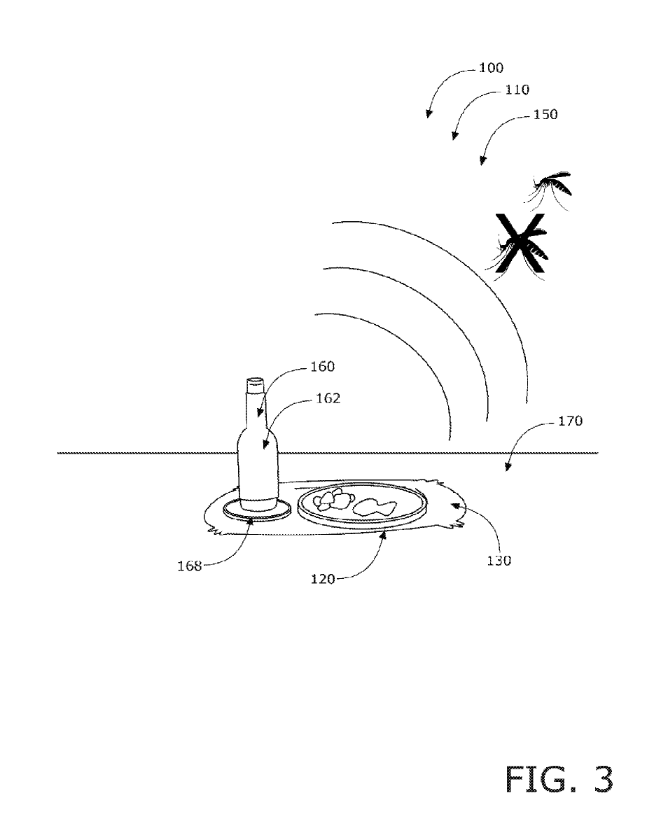

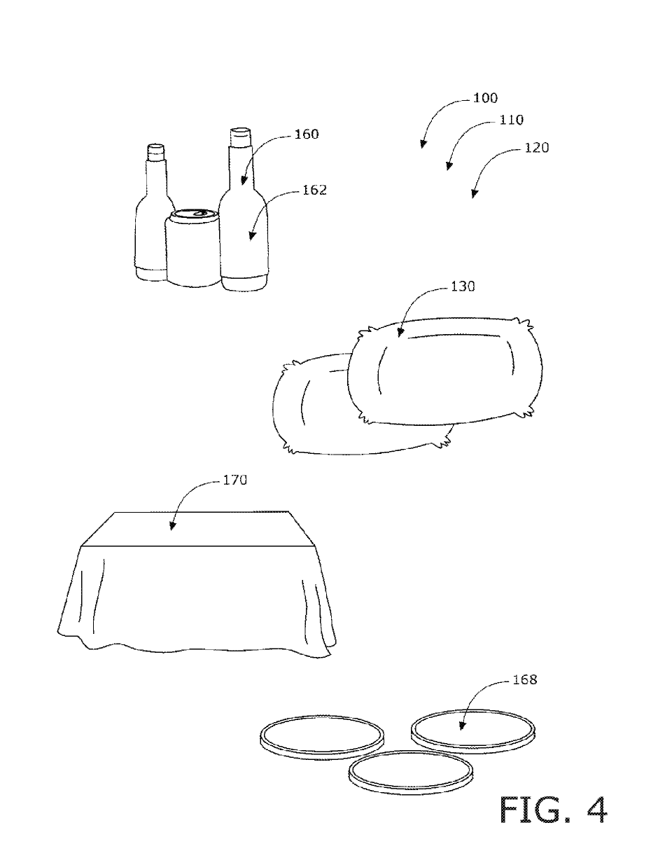

Referring now more specifically to the drawings by numerals of reference there is shown in FIGS. 1-4, various views of insect repelling system 100 comprising: insect repellant table setting 110 having at least one place-setting 120 including at least one place mat 130, at least one beverage holder 160, and at least one coaster 168, and at least one table cloth 170.

Insect repellant table setting 110 comprises in functional combination least one place-setting 120 and at least one table cloth 170. At least one place-setting 120 comprises at least one place mat 130, at least one beverage holder 160; and at least one coaster 168 to be used for outdoor dining purposes. Insect repellant table setting 110 is treated with insect repellant such that outdoor dining is made more enjoyable for food and drink consumers by repelling insects from an area proximate to insect repellant table setting 110.

Treating may comprise impregnation or other suitable means. Insect repellant may comprise Permethrin or the like. Permethrin is imbued and infused with fabric of said insect repellant table setting. Insect repellant table setting 110 is coated with a non-stick material to further assist in preventing movement of crawling insects. Insect repellant comprises citronella oil for repelling insects. Insect repellant is environmentally-friendly. Insect repellant is non-toxic. Insect repellant is herbal and prevents insects from coming near and landing on drinks and food outside. At least one beverage holder 160 is insulated koozie 162. Insulated koozie 162 is designed for holding and insulating a bottled drink. Insulated koozie 162 is designed for holding and insulating a canned-drink. At least one table cloth 170 is flexible. At least one coaster 168 comprises a greater circumference than that of a base of at least one beverage holder 160. At least one coaster 168 provides a protective layer between at least one table cloth 170 and at least one beverage holder 160. Insect repellant comprises nn-diethyl-meta-toluamide for protection against insect bites.

Insect repelling system 100 may be sold as a kit comprising the following parts at least one place-setting; at least one table cloth; and at least one set of user instructions. The kit has instructions such that functional relationships are detailed in relation to the structure of the invention (such that the invention can be used, maintained, or the like in a preferred manner). including,

Insect repelling system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An insect repelling system comprising:
an insect repellant table setting having,
at least one place-setting including,
at least one place mat;
at least one beverage holder; and
at least one coaster; and
at least one table cloth,
wherein said insect repellant table setting comprises in functional combination said least one place-setting and said at least one table cloth;
wherein said at least one place-setting comprises at least said at least one place mat, said at least one beverage holder; and said at least one coaster to be used for outdoor dining purposes; and
wherein said insect repellant table setting is treated with insect repellant such that during said outdoor dining is made more enjoyable for food and drink consumers by repelling insects from an area proximate to said insect repellant table setting.

2. The insect repelling system of claim 1 wherein said treated comprises impregnation.

3. The insect repelling system of claim 1 wherein said insect repellant comprises permethrin.

4. The insect repelling system of claim 3 wherein said permethrin is imbued and infused with fabric of said insect repellant table setting.

5. The insect repelling system of claim 1 wherein said insect repellant table setting is coated with a non-stick material to further assist in preventing movement of crawling said insects.

6. The insect repelling system of claim 1 wherein said insect repellant comprises citronella oil for repelling said insects.

7. The insect repelling system of claim 1 wherein said insect repellant is environmentally-friendly.

8. The insect repelling system of claim 9 wherein said insect repellant is non-toxic.

9. The insect repelling system of claim 9 wherein said insect repellant is herbal and prevents insects from coming near and landing on drinks and said food outside.

10. The insect repelling system of claim 1 wherein said at least one beverage holder is an insulated koozie.

11. The insect repelling system of claim 10 wherein said insulated koozie is designed for holding and insulating a bottled drink.

12. The insect repelling system of claim 11 wherein said insulated koozie is designed for holding and insulating a canned-drink.

13. The insect repelling system of claim 1 wherein said at least one table cloth is flexible.

14. The insect repelling system of claim 1 wherein said at least one coaster comprises a greater circumference than that of a base of said at least one beverage holder.

15. The insect repelling system of claim 1 wherein said at least one coaster provides a protective layer between said at least one table cloth and said at least one beverage holder.

16. The insect repelling system of claim 1 wherein said insect repellant comprises nn-diethyl-meta-toluamide for protection against bites by said insect(s).

17. An insect repelling system comprising:
an insect repellant table setting having,
at least one place-setting including,
at least one place mat;
at least one beverage holder; and
at least one coaster; and
at least one table cloth,
wherein said insect repellant table setting comprises in functional combination said least one place-setting and said at least one table cloth;
wherein said at least one place-setting comprises at least said at least one place mat, said at least one beverage holder; and said at least one coaster to be used for outdoor dining purposes;
wherein said insect repellant table setting is treated with insect repellant such that during said outdoor dining is made more enjoyable for food and drink consumers by repelling insects from an area proximate to said insect repellant table setting;
wherein said treated comprises impregnation;
wherein said insect repellant comprises permethrin;
wherein said permethrin is imbued and infused with fabric of said insect repellant table setting;
wherein said insect repellant comprises citronella oil for repelling insects;
wherein said insect repellant is environmentally-friendly;
wherein said insect repellant is non-toxic;
wherein said insect repellant is herbal and prevents insects from coming near and landing on drinks and said food outside;
wherein said insect repellant table setting is coated with a non-stick material to further assist in preventing movement of crawling insects;
wherein said at least one beverage holder is an insulated koozie;
wherein said insulated koozie is designed for holding and insulating a bottled drink;
wherein said at least one table cloth is flexible;
wherein said at least one coaster comprises a greater circumference than that of a base of said at least one beverage holder;
wherein said at least one coaster provides a protective layer between said at least one table cloth and said at least one beverage holder; and
wherein said insect repellant comprises nn-diethyl-meta-toluamide for protection against bites by said insect(s).
